(19) United States
(12) Patent Application Publication
(10) Pub. No.: US 2009/0326916 A1
(43) Pub. Date: Dec. 31, 2009

(54) UNSUPERVISED CHINESE WORD SEGMENTATION FOR STATISTICAL MACHINE TRANSLATION

(75) Inventors: Jianfeng Gao, Kirkland, WA (US); Kristina Nikolova Toutanova, Redmond, WA (US); Jia Xu, Aachen (DE)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/163,119

(22) Filed: Jun. 27, 2008

(51) Int. Cl. G06F 17/28

(52) U.S. Cl. 704/4

(57) ABSTRACT

Described is using a generative model in processing an unsegmented sentence into a segmented sentence. A segmenter includes the generative model, which given an unsegmented sentence (e.g., in Chinese) provides candidate segmented sentences to a probability-based decoder that selects the segmented sentence. For example, the segmented (e.g., Chinese-language) sentence may be provided to a statistical machine translator that outputs a translated (e.g., English-language) sentence. The generative model may include a word sub-model that generates hidden words using a word model, a spelling sub-model that generates characters from the hidden words, and an alignment sub-model that generates translated words and alignment data from the characters. The word sub-model may correspond to a unigram model having words and associated frequency data therein, and the alignment sub-model may correspond to a word aligned corpus having source sentence, translated target sentence pairings therein. Training is also described.

### BACKGROUND

There is no space between words in Chinese text. As a result, Chinese word segmentation is a necessary initial step for natural language processing applications, such as machine translation applications, that use words as a basic processing unit.

However, there is no widely-accepted definition of what is a Chinese word. What is considered the “best” word segmentation usually varies from application to application. For example, automatic speech recognition systems prefer “longer words” that provide more context and less ambiguity, to thereby achieve higher accuracy, whereas information retrieval systems prefer “shorter words” to obtain higher recall rates.

The most widely-used Chinese word segmentation systems, such the LDC word breaker, are generic in that were not designed with any specific application in mind. Therefore, they may be suboptimal when used in a specific application. For example, in machine translation, a segmenter needs to be able to chop sentences into segments that each can be translated as a unit. However, some of these segments may not be viewed as words by the LDC word segmentation system, because certain segments will not be correspond to words in the LDC dictionary based on where the word breaker chopped the text.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an unsegmented sentence is processed into a segmented sentence via a segmenter that includes a generative model. The generative model may provide candidate segmentation sentences to a decoder that selects as the segmented sentence a candidate segmented sentence based on probability. For example, the segmented sentence may be provided to a statistical machine translator that outputs a translated sentence from the translator.

In one aspect, the generative model includes a word sub-model that generates hidden words using a word model, a spelling sub-model that generates characters from the hidden words, and an alignment sub-model that generates translated words and alignment data from the characters. The word sub-model may correspond to a unigram model having words and associated frequency data therein, and the alignment sub-model may correspond to a word aligned corpus having source sentence, translated target sentence pairings therein. Training may be used to obtain a parameter set for combining the sub-models.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is block diagram representing an example environment for segmenting an input sentence into a segmented sentence based on a generative model.

FIG. 2 is a block diagram representing an example environment for translating a source sentence into a translated sentence using the segmenting of FIG. 1.

FIGS. 3A-3C are representations of a Chinese sentence and an English translation thereof based up segmentation.

FIG. 4 is a block diagram representing a generative model comprised of sub-models.

FIG. 5 is a flow diagram representing steps corresponding to the sub-models of a generative model.

FIG. 6 shows an illustrative example of a computing environment into which various aspects of the present invention may be incorporated.

### DETAILED DESCRIPTION

Various aspects of the technology described herein are generally directed towards a Chinese word segmentation system that is designed for a particular application, rather than being a general system for varied applications. In one aspect, Chinese word segmentation and word alignment are jointly combined for the purpose of statistical machine translation (SMT) applications A generative model evaluates the quality (“goodness”) of a Chinese word in a statistical machine translation application; also described is Bayesian estimation of the generative model.

While some of the examples described herein are directed towards statistical machine translation, other uses, such as in speech recognition, may benefit from the segmentation technology described herein. Further, while the examples show segmentation and/or translation from the Chinese language to the English language, it is understood that other languages may be substituted. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and text processing in general.

By way of example, described is a Chinese word segmentation system that is designed with the application of statistical machine translation in mind. One of the core components of most statistical machine translation systems is a translation model, which is a list of translation pairs. Take Chinese to English translation as an example. Each translation pair is a segment of Chinese text (a sequence of Chinese characters) and its candidate English translation. Such Chinese segments may or may not be defined as words in a traditional Chinese dictionary, but they are translation units, which the statistical machine translation system uses to generate the English translation of the input Chinese sentence. These translation pairs are learned from a word-aligned parallel corpus, where the Chinese sentences need to be word-segmented.

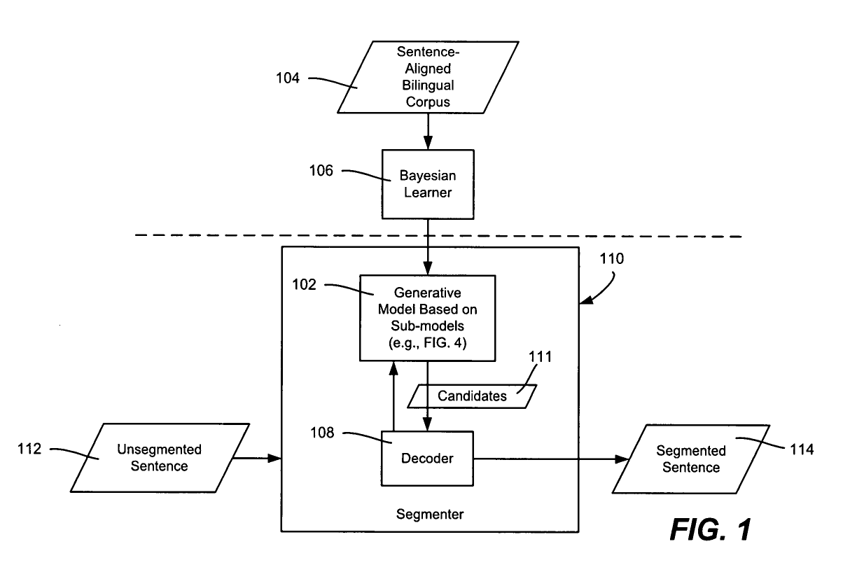

FIG. 1 shows a generalized block diagram of how a generative model 102 is learned using a sampling method described below. In this example, a learning mechanism (e.g., Bayesian learner 104) takes as its input a sentence-aligned bilingual corpus 106, and outputs the generative model. Once generated, the generative model 102, along with a decoder 108 comprise the segmenter 110.

In general, the decoder 108 uses the generative model 102 to segment a Chinese sentence. To this end, the decoder takes an unsegmented sentence as input and implicitly (e.g., via a dynamic programming method that finds the n-best candidates 111) takes into account the possible segmentations and ranks them by probability.

As represented in FIG. 1, at some later time, (e.g., as represented by the dashed line in FIG. 1), the segmenter 110 may be used for word segmenting. In this example, an input (e.g., Chinese) sentence 112 is fed to the segmenter 110, which then outputs a word-segmented Chinese sentence 114.

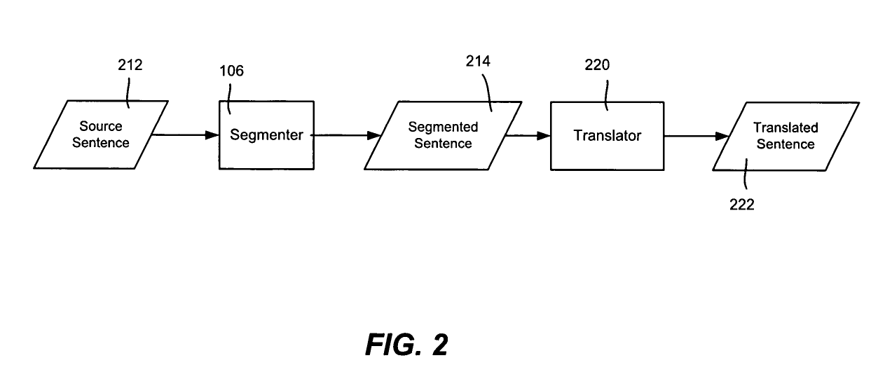

Thus, once the generative model has been developed, it may be used to segment sentences, such as to obtain a word-aligned corpus for translation model training, or to obtain a segmented sentence as input of a machine translation system. By way of example, FIG. 2 shows a generalized block diagram of how translation works once the segmenter 106 has been developed. Given a source sentence (or phrase) 212, the segmenter 106 outputs a segmented sentence 214, which is then fed into a translator 220, e.g., a statistical machine translator. The output is a translated sentence 222. Thus, in one aspect, the Chinese word segmentation system described herein works to jointly optimize the accuracies of Chinese word segmentation and word alignment so that the segmented Chinese words are, as much as possible, translated as a unit, that is, processed as a translation unit.

In statistical machine translation, when the system is given a source language sentence (Chinese in this example), c, which is to be translated into a target language sentence (English in this example) e, among all possible English sentences, the system chooses the one with the highest probability:

e*=argmax_{eεGEN(c)}P(e|c) (1)

where argmax denotes the search process. The posterior probability P(e|c) is modeled directly using a log-linear combination of several sub-models, sometimes called features, as:

$$P ( e \vert c ) = \frac{exp ( {\sum }_{m = 1 … M} {λ}_{m} {h}_{m} ( e , c ) )}{{\sum }_{e ∈ GEN ( c )} exp ( {\sum }_{m = 1 … M} {λ}_{m} {h}_{m} ( e , c ) )} \qquad ( 2 )$$

where GEN(c) denotes the set of all possible English translations that map to the source Chinese sentence c. Because the denominator term in Equation (2) is a normalization factor that depends only upon the Chinese sentence c, it may be dropped during the search process, whereby the decision rule is:

$${e}^{*} = \text{arg} {max}_{e ∈ GEN ( c )} exp ( {\sum }_{m = 1}^{M} {λ}_{m} {h}_{m} ( e , c ) ) \qquad ( 3 )$$

This approach is a generalization of a known source-channel approach. It has the advantage that additional models h(.) can be easily integrated into the overall system. The model scaling factors λ are trained with respect to the final translation quality measured in a known manner.

The translation model may be based on sub-models. One such sub-model is the translation model of the form P(e|c) (or P(c|e)). Because it is too expensive to model the translation probability at the sentence level, the sentence is decomposed, providing the probability P(e|c) as a product of translation probabilities of smaller chunks that are assumed to be independent. It is the definition of those chunks that distinguishes different types of state-of-the-art statistical machine translation systems. In particular, if each chunk is defined as a sequence of contiguous words/characters, called a phrase, the result is what is commonly referred to as a phrasal-based statistical machine translation system.

In a phrasal-based statistical machine translation system, the translation model contains a list of phrase translation pairs, each with a set of translation scores. The translation model is typically trained on a (English-Chinese) parallel corpus by word-segmenting Chinese sentences, and tokenizing English sentences. Then, a word alignment is established between each pair of aligned English and Chinese sentences. Aligned phrases (translation pairs) are extracted from the word-aligned corpus, and translation scores are estimated using a maximum likelihood estimation (MLE) method.

The well-known LDC word breaker contains a dictionary of around 10,000 word entries (including all single-character-words), and a unigram model, where for each word in the dictionary, there is a score (or probability) derived from its frequency in a word-segmented corpus. During runtime, given an input Chinese sentence, which is a character sequence c=c₁ . . . c_{I}, among all possible generated by the dictionary wεGEN(c), the LDC word breaker chooses the best word sequence w*=w₁ . . . w_{J} that maximizes the conditional probability as:

w*=argmax_{wεGEN(c)}P(w|c)=argmax_{wεGEN(c)}P(c|w)P(w) (4)

Assuming that given a word, its character string is determined, P(c|w)=1. Therefore the decision of Equation (4) depends solely upon the language model probability P(w), which is assigned by a unigram model:

$$P ( w ) = {\prod }_{i = 1 … I} P ( {w}_{i} ) \qquad ( 5 )$$

The search is performed by a dynamic programming algorithm called the Viterbi decoding algorithm. The unigram model is typically trained on word-segmented Chinese monolingual corpus using maximum likelihood estimation. That is, the best word segmentation model is assumed to be the one that maximizes the likelihood of the model parameters given the monolingual Chinese data which is segmented.

When applying the LDC word breaker to statistical machine translation, there are problems that lead to suboptimal MT results. One is based on a dictionary issue, also called the word type issue. Because the dictionary is predefined without the application of statistical machine translation in mind, the word breaker can only segment an input sentence into a sequence of words that are stored in the dictionary; any out-of-vocabulary (OOV) words are treated as single-character words. Thus, it is often the situation that a sequence of characters that are easier to translate as a unit may be not stored in the dictionary as a word, but instead those characters are chopped into individual segments.

Another problem is based upon a word distribution (represented by the unigram model) issue, also called the word token issue. The distribution of words guides how the best word sequence is determined. However, that model is trained on a monolingual corpus. Ideally, the model is able to determine the best word sequence that would lead to best translations; formally, let e denote the English translation of the input Chinese sentence c. The best segmentation w is the one that maximize the translation probability as:

w*=argmax_{wεGEN(c)}P(w|e,c) (6)

That is, the best word segmentation model is the one that maximizes the likelihood of the model parameters given the parallel bilingual data.

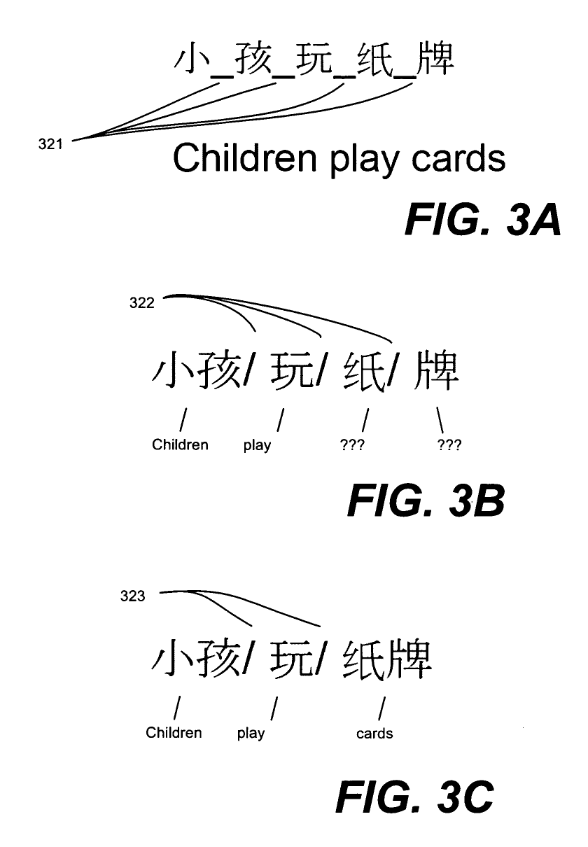

By way of example of the aforementioned issues, consider FIG. 3A (corresponding to the tables below), which shows a five-character Chinese sentence and its English translation. As represented in FIG. 3A, the four underscore (_) characters 321 are provided to better delineate the separate characters. The LDC word breaker segments the sentence into a four word sequence as shown in FIG. 3B, in which the three slash (/) characters 322 are shown to delineate the four separate segments.

Note that in FIG. 3B, the character sequence zhi3-pai2 (comprising the last two Chinese characters) is segmented into two single-character words. However, the correct translation is into one word, the English word “card”, as shown in FIG. 3C; in FIG. 3C, two slash (/) characters 323 are shown to delineate the three separate segments.

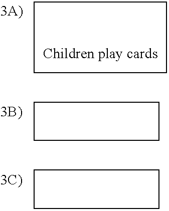

The technology described herein solves both the word type and word token issues simultaneously. To this end, there is provided a unified approach to both word segmentation and word-alignment problems, which in general operates by extending the maximum likelihood principle from its known monolingual model to a new bilingual model.

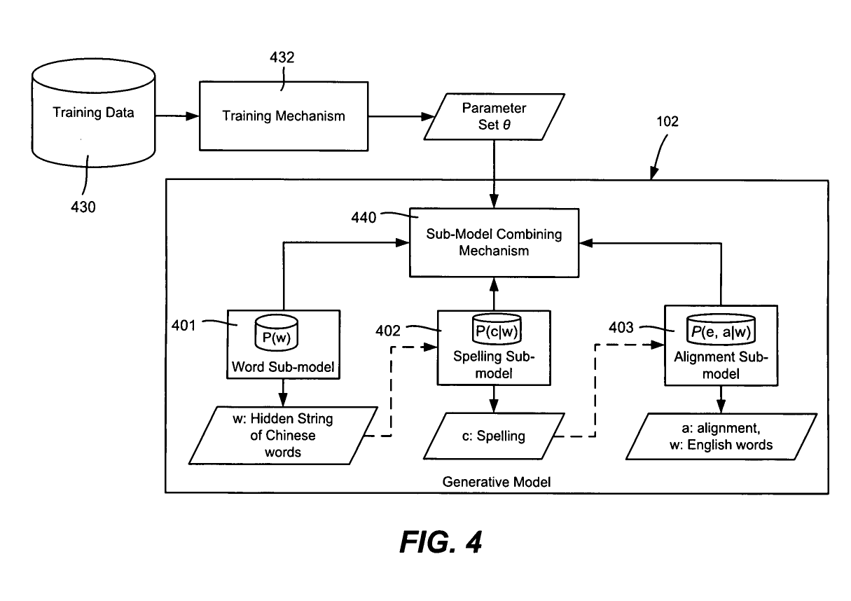

As described with reference to FIG. 4, various aspects of an unsupervised Chinese word segmentation for statistical machine translation are based upon a word segmentation system that uses no dictionary and requires no word-segmented corpus as training data. Instead, the system uses a sentence-aligned bilingual corpus, which may be the same corpus used to extract translation pairs. That is, the exemplified system uses an unsupervised learning approach to word segmentation that leads to better word-alignment, and thus produces more translation-friendly Chinese segments/words that can be translated as units to the extent possible.

To this end, there is provided the generative model 102 that models the process of generating a pair of English-Chinese parallel sentences (where the two sentences are translations of each other) and models the Chinese words as hidden variables. Then, the hidden variables (Chinese words) are inferred, via Gibbs sampling in one implementation.

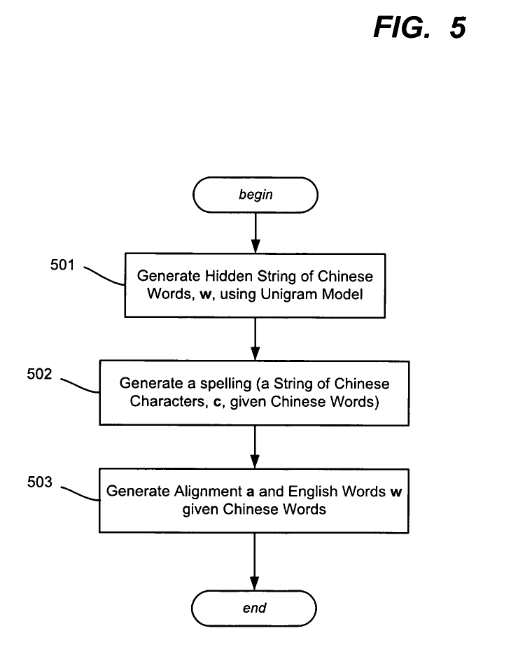

To describe the generative model 102, Let e, a, w and c denote English words (e), alignment (a), Chinese words (w) and Chinese characters (c), respectively. As will be understood, the generative model 102 generates a word-aligned English-Chinese sentence pair via three steps, or sub-models, as represented in FIG. 5:
Step 501: a word sub-model 401, P(w), generates a hidden string of Chinese words, using a unigram model;
Step 502: a spelling sub-model 402 generates a spelling, which is a string of Chinese characters, c; and
Step 503: An alignment model 403 generates an alignment, a, and English words, w, given Chinese words.

In one implementation, the word sub-model 401, P(w), is a word unigram model of Equation (5):

$$P ( w ) = {\prod }_{i = 1 … I} P ( {w}_{i} )$$

where the unigram probabilities are estimated using maximum likelihood estimation (together with a smoothing method to avoid zero probability) as:

$$P ( w ) = \frac{n ( w )}{N} \qquad ( 7 )$$

where N is the number of words in training data and n(w) is the number of words w in training data.

The spelling model 402, P(c|w), generates a spelling c=c₁ . . . c_{K} given a word w. If the word is a new word (a word that has not been observed in the corpus before), denoted by NW, the probability is

$$P ( {c}_{1} … {c}_{K} \vert NW ) = \frac{{λ}^{k}}{K !} {e}^{- λ} {p}^{K} \qquad ( 8 )$$

Equation (8) contains two terms. First, assume that the length of Chinese words follows a Poisson distribution with parameter λ>0. The probability of length K is

$$P ( K \vert λ ) = \frac{{λ}^{k}}{K !} {e}^{- λ} .$$

Second, given the length K, the probability of a new word can be estimated via a character unigram model: P(w)=Π_{k=1 . . . K}P(cₖ). For simplicity, assume a uniform distribution over all Chinese characters, P(c)=p and P(w)=p^{K}, where 1/P is the number of Chinese character characters (i.e., 6675 in this case).

If the word has been observed before, denoted by LW, assume that the probability is one:

P(c₁ . . . c_{K}|LW,w)=1 (9)

Combining Equations (8) and (9), using the sum rule, gives:

P(c,w)=P(LW)P(w|LW)P(c|LW,w)+P(NW)P(c|NW) (10)

Let α=P(NW) and P₀=P(c|NW, w); substituting Equations (7) and (9) into (10), results in:

P(c,w)=(1−α)P(w)+αP₀ (11)

where P(w) is defined in Equation (5), and P₀ is defined in Equation (8). Equation (11) may also be derived from the framework of Bayesian estimation, where αP₀ may be interpreted as a probability mass derived from the pseudo-count of w, i.e., the prior (or pre-knowledge of the) count of w without observing any data. Therefore Equation (11) may also be referred to as a Bayes-smoothing estimate, where w is assumed to draw from a multinomial distribution and with a Dirichlet prior distribution parameterized by α.

The alignment model 403 generates the alignment and English words given Chinese words. Taking the well-known IBM Model 2 as an example, the alignment model 403, P(e, a|w), may be structured as:

$$P ( e , a \vert w ) = P ( J \vert I ) {\prod }_{j = 1}^{J} [ P ( {a}_{j} \vert j , I ) P ( {e}_{j} \vert {w}_{aj} ) ] \qquad ( 12 )$$

The probability is decomposed into three different probabilities: (1) a length probability P(J|I), where I is the length of w and J is the length of e; (2) an alignment probability P(aⱼ|J, I), where the probability only depends on j and I; (in the IBM Model, assume a uniform distribution P(aⱼ|J,I)=1/(I+1)^{J}, i.e., the word order does affect the alignment probability); and (3) a lexicon probability P(eⱼ|wₐⱼ) where it is assumed that the probability of an English translation e only depends on its aligned Chinese word.

Other models may be used, such as a Hidden Markov Model or a fertility-based alignment model. For simplicity, the alignment is restricted so that for each English word, there is only one aligned Chinese word, although one Chinese word may align to multiple English words. However, during the inference as described above, the system deals with situations in which one English word maps to two or more Chinese words. For example, in sampling, consider whether wₐⱼ in Equation (13) is to be divided into two words w₁ and w₂. To compute P(e|w₁,w₂), which is originally P(e|wₐⱼ), a straightforward heuristic is to use the linear combination:

P(e|wₐⱼ)=P(e|w₁,w₂)=0.5×P(e|w₁)+0.5×P(e|w₂)

An alternative solution is to use more sophisticated alignment models such as the fertility-based alignment models that capture one-to-many mappings.

Combining the three sub-models, e.g., represented in FIG. 4 via the combining mechanism 440, obtains the generative model, decomposed as follows:

$$\begin{matrix}P ( e , a , c ) = {\sum }_{w = GEN ( c )} P ( e , a , c , w ) \\ = {\sum }_{w = GEN ( c )} P ( w ) P ( c \vert w ) P ( e , a \vert w ) \\ = {\sum }_{w = GEN ( c )} P ( w , c ) P ( e , a \vert w )\end{matrix} \qquad ( 13 )$$

The generative model of Equation (13) depends on a set of free parameters θ that is to be learned from training data 430 as processed by a training mechanism 432. The set θ comprises word probability P(w), length probability P(J|I), alignment probability P(a|J,I) and translation probability P(e|w); α, as shown in Equation (11), is a prior that is empirically chosen (e.g., by optimizing on development data).

For simplicity herein, the training data 430 is denoted as a list of d=(e, c, a). Given training data 430, or D=(d₁, . . . , dₙ), a goal is to infer the production probabilities θ that best describe the data D. Appling the Bayes' rule:

P(θ|D)∝P(D|θ)P(θ), where

P(D|θ)=Π_{i=1 . . . n}P(dᵢ|θ) (14)

where P(θ) is the prior distribution that depends on α.

Using W to denote a sequence of words for D, the joint posterior distribution over W and θ may be computed, and then marginalizing over W, with P(θ|D)=Σ_{W}P(W,θ|D); the joint posterior distribution on W and θ is given by:

$$P ( W , θ \vert D ) ∝ P ( D \vert W ) P ( W \vert θ ) P ( θ ) = ( {\prod }_{i = 1 … n} P ( {d}_{i} \vert {w}_{i} ) P ( {w}_{i} \vert θ ) ) P ( θ ) \qquad ( 15 )$$

Computing the posterior probability of Equation (15) is intractable because evaluating the normalization factor (i.e., partition function) for this distribution requires summing over all possible w for each d in training data. notwithstanding, it is possible to define algorithms using Markov chain Monte Carlo (MCMC) that produce a stream of samples from this posterior distribution instead of producing a single model that characterizes the posterior.

The known Gibbs sampler is one of the simpler MCMC methods, in which transitions between states of the Markov chain result from sampling each component of the state conditioned on the current value of all other variables. In the present example, this means alternating between sampling from two distributions P(W|D,θ) and P(θ|D,W). That is, every two steps generate a new sample of W and θ. This alternation between word segmentation and updating θ is similar to the EM (Expectation-Maximization) algorithm, with the E-step replaced by sampling W and the M-step replaced by sampling θ.

The following algorithm sets forth one Gibbs sampler for Chinese word segmentation:

Algorithm: Gibbs sampling for Chinese word segmentation

```
Input: D and an initial W (i.e., each Chinese character as a word).
Output: D and the sampled W
for t = 1 to T
  for each sentence pair d in D, randomized order
      Create two hypotheses, h⁺ and h⁻, where
        h⁺: there is a word boundary, and the corresponding word
sequence of c is denoted by w⁺
      h⁻: there is no word boundary, and the corresponding word
sequence of c is denoted by w⁻
    Compute the probabilities of the two hypotheses using Equation (14):
      P(w⁺|d, θ ) ∝ P(d, w⁺ |θ), and
      P(w⁻|d, θ ) ∝ P(d, w⁻ |θ)
    Sample the boundary based on P(w⁺) and P(w⁻).
    Update θ.
```

Given the Gibbs sampler above, one example system performs a joint optimization of word segmentation and word alignment using the algorithm below:

```
Initialization: start with Chinese character strings (where each Chinese
character is viewed as a word),
and run word alignment (in a known manner).
for n = 1 to N
  Run the Gibbs sampling until it converges. The resulting samples are
denoted by (D,W)
  Run word alignment on (D, W)
```

Returning to the example in FIGS. 1A-1C, computing the probabilities of different hypotheses for sampling is described. To simplify the description, the three-word English sentence in FIG. 3A is denoted as e=(e₁, e₂, e₃), and the five-character Chinese sentence in FIG. 3A as c=(c₁, c₂, c₃, c₄, c₅). The alignment between e and c are (e₁, c₁) (e₁, c₂) (e₂, c₃) (e₃, c₄) and (e₃, c₅). Consider the two segmentations shown in FIGS. 3B and 3C, there is one segmentation hypothesis: w⁻=c₁ c₂/c₃/c₄c₅ (FIG. 3B), and another hypothesis: w⁺=c₁c₂/c₃/c₄/c₅ (FIG. 3C). Equation (13) shows that P(w, d) is comprised of the monolingual probability P(w, c) and bilingual probability P(e, a|w).

The following monolingual probabilities compare the two hypotheses:

P(w⁺,c)∝(1−α)P(c₄,c₅)+αP₀(c₄,c₅)

P(w⁻,c)∝[(1−α)P(c₄)+αP₀(c₄)]×[(1−α)P(c₅)+αP₀(c₅)]

Considering the IBM Model 1 of Equation (12), the following bilingual probabilities may be used to compare the two hypotheses:

P(e,a|w⁺)∝P(3|3)P(e₃|c₄c₅)

P(e,a|w⁻)∝P(3|4)[0.5P(e₃|c₄)+0.5P(e₃|c₅)]

### Exemplary Operating Environment

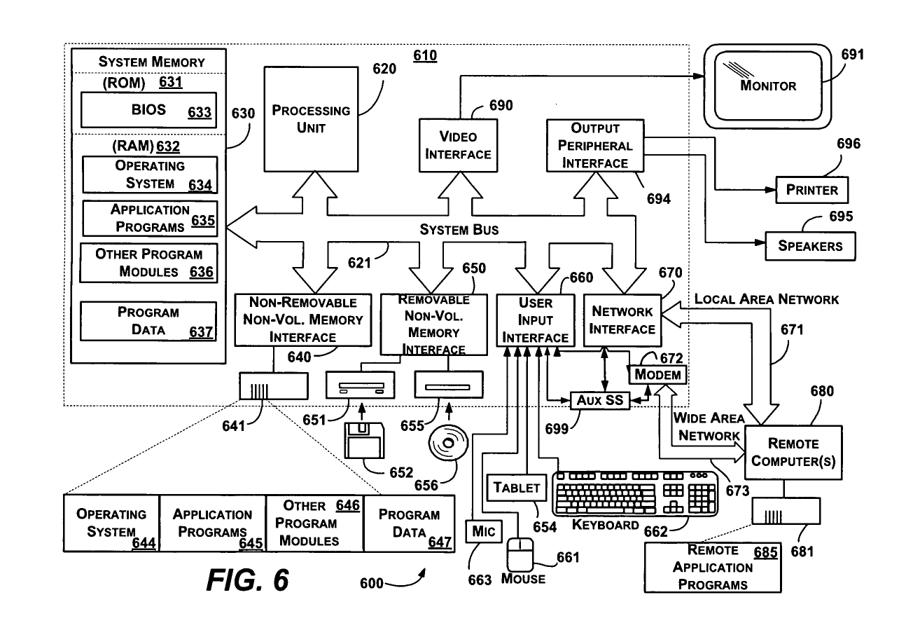

FIG. 6 illustrates an example of a suitable computing and networking environment 600 on which the examples and/or implementations of FIGS. 1-5 may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, embedded systems, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 655 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 645 and program data 647. Note that these components can either be the same as or different from operating system 634, application programs 635, other program modules 635, and program data 637. Operating system 644, application programs 645, other program modules 645, and program data 647 are given different numbers herein to illustrate that, at a minimum, they are different copies. A user may enter commands and information into the computer 610 through input devices such as a tablet, or electronic digitizer, 654, a microphone 653, a keyboard 652 and pointing device 651, commonly referred to as mouse, trackball or touch pad. Other input devices not shown in FIG. 6 may include a joystick, game pad, satellite dish, scanner, or the like. These and other input devices are often connected to the processing unit 620 through a user input interface 650 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 695, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 650 or other appropriate mechanism. A wireless networking component 674 such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 650 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising:
receiving an unsegmented sentence; and
segmenting the unsegmented sentence into a segmented sentence via a segmenter that includes a generative model.

2. The method of claim 1 wherein the segmenter further includes a decoder that obtains candidate segmented sentences from the generative model and selects as the segmented sentence a candidate segmented sentence based on probability.

3. The method of claim 1 further comprising, providing the segmented sentence to a translator and receiving a translated sentence from the translator.

4. The method of claim 3 wherein the unsegmented sentence comprises a Chinese-language sentence, and wherein the translated sentence comprises an English-language sentence.

5. The method of claim 1 wherein segmenting the unsegmented sentence comprises, generating hidden words using a word model, generating characters from the hidden words, and generating the translated sentence from the characters.

6. The method of claim 1 further comprising, providing the generative model by combining sub-models, including a word sub-model, a spelling sub-model and an alignment sub-model.

7. The method of claim 6 further comprising, generating a hidden string of words via the word sub-model.

8. The method of claim 7 wherein generating the hidden string of words comprises modeling the words as hidden variables, and inferring the hidden variables via Gibbs sampling.

9. The method of claim 7 further comprising, providing the hidden string of words to the spelling sub-model, and generating a string of characters from the hidden string of words via the spelling sub-model.

10. The method of claim 6 further comprising, providing a string of characters to the alignment sub-model.

11. The method of claim 1 further comprising, providing the generative model, including using a parameter set to combine sub-models.

12. The method of claim 11 wherein the parameter set corresponds to word probability, length probability, alignment probability or translation probability, or any combination of word probability, length probability, alignment probability or translation probability.

13. The method of claim 11 further comprising, processing training data to obtain the parameter set.

14. In a computing environment, a system comprising, a generative model, including a word sub-model that generates hidden words using a word model, a spelling sub-model that generates characters from the hidden words, and an alignment sub-model that generates translated words and alignment data from the characters.

15. The system of claim 14 further comprising, a segmenter that includes the generative model for segmenting an unsegmented sentence into candidates, and a decoder for processing the candidates to select the best candidate as a segmented sentence.

16. The system of claim 14 further comprising, means for determining a parameter set used by the generative model in combining sub-models.

17. The system of claim 14 wherein the word sub-model corresponds to a unigram model having words and associated frequency data therein, and wherein the alignment sub-model corresponds to a word aligned corpus having source sentence, translated target sentence pairings therein.

18. In a computing environment, a method comprising, configuring a generative model for use in segmenting an unsegmented sentence, including generating hidden words using a word model, generating characters from the hidden words, and generating candidate segmented sentences from the characters.

19. The method of claim 18 further comprising, selecting a candidate as a segmented sentence based on probability data.

20. The method of claim 18 further comprising, using training data to configure at least part of the generative model.
